(19) United States
(12) Patent Application Publication
(10) Pub. No.: US 2025/0326503 A1
(43) Pub. Date: Oct. 23, 2025

(54) Trajectory Planning Around Lagrange Points

(71) Applicant: The Charles Stark Draper Laboratory, Inc., Cambridge, MA (US)

(72) Inventors: Hailee Hetrick, Cambridge, MA (US); Begum Cannataro, Cambridge, MA (US); David Miller, Cambridge, MA (US)

(21) Appl. No.: 19/184,229

(22) Filed: Apr. 21, 2025

Related U.S. Application Data
(60) Provisional application No. 63/636,247, filed on Apr. 19, 2024.

(51) Int. Cl. B64G 1/24

(52) U.S. Cl. CPC B64G 1/2422

(57) ABSTRACT

A system for planning a mission for spacecraft flying in formation includes an input for receiving data representing a sequence of spatial configurations of the number of spacecraft and a retargeting module configured to generate instructions for causing the number of spacecraft to transition between spatial configurations of the sequence of spatial configurations, including determining a trajectory with periods of fuel-free motion and periods of actuated motion according to a fuel limitation constraint for at least one spacecraft of the number of spacecraft.

### CROSS-REFERENCES TO RELATED APPLICATIONS

This application claims the benefit of U.S. Provisional Application No. 63/636,247 filed Apr. 19, 2024, the entire contents of which are incorporated herein by reference.

### BACKGROUND OF THE INVENTION

Investigation of exoplanets residing in habitable zones of other solar systems is an active area of research, furthering humanity's understanding of the universe by searching for extraterrestrial life. Thus far, indirect detection methods have identified a vast quantity of exoplanets in habitable zones of other solar systems. However, such methods are inadequate for fully characterizing exoplanets.

### SUMMARY OF THE INVENTION

A solution to this inadequacy is to develop technological advancements in space-based telescopes and onboard instruments. One such technological advancement is the proposed use of an external occulter, commonly referred to as a “starshade,” flying in formation with a space-based telescope. The starshade flies tens of thousands of kilometers in front of the telescope along an inertially constant line-of-sight (LOS) vector with the target star, suppressing its light from the telescope's pupil, thereby enabling direct imaging of exoplanets.

While a telescope and starshade formation flying mission addresses the imaging capabilities required for exoplanet characterization, the addition of a second spacecraft (i.e., the starshade) introduces some drawbacks. For example, there are inherent costs of production and launch and launch of the starshade, which are unavoidable. Furthermore, there are costs associated with retargeting the formation line-of-sight between imaging phases. The costs of retargeting the formation include both time and fuel expenditures, which may adversely affect the potential science yield of the mission.

Aspects described herein minimize the time and fuel expenditures associated with retargeting the formation by leveraging naturally occurring dynamics of the formation's location in space.

In one general aspect, the telescope and starshade formation operates in the regime of the Sun-Earth L2. In general, Lagrange points are equilibrium points in the dynamics of a negligibly small mass object under the gravitational influence of two massive, celestial bodies orbiting one another. The second Lagrange point of the Sun-Earth system provides several advantages from an imaging standpoint, and it also offers a rich solution space of naturally occurring dynamics well-known to the circular restricted three-body problem. Aspects employ Dynamical Systems Theory to the telescope and starshade formation to exploit fuel-free motion. Aspects also recognize that the starshade can be modeled under the influence of solar radiation pressure (SRP), which expands the domain of fuel-free trajectories it can exploit by treating SRP as a means of actuation rather than a perturbation to be corrected. Aspects may use approximate analytical techniques for nonlinear systems to solve the equations for the motion of the telescope and starshade in a computationally efficient manner.

In a general aspect, a system for planning a mission for a number of spacecraft flying in formation includes an input for receiving data representing a sequence of spatial configurations of the number of spacecraft and a retargeting module configured to generate instructions for causing the number of spacecraft to transition between spatial configurations of the sequence of spatial configurations, including determining a trajectory with periods of fuel-free motion and periods of actuated motion according to a fuel limitation constraint for at least one spacecraft of the number of spacecraft.

Aspects may have one or more of the following features. A first spacecraft of the number of spacecraft may be in a halo orbit around a Lagrange point. A second spacecraft may be in an orbit substantially affected by two astronomical bodies. The second spacecraft's orbit may be substantially affected by solar radiation pressure. The second spacecraft may be under the fuel limitation constraint. The trajectory may be determined using an approximate analytical solution to the circular restricted three-body problem (CR3BP) with non-Hamiltonian solar radiation pressure.

The system may include an output for providing a mission plan including the instructions to at least some spacecraft of the number of spacecraft. At least one spacecraft may be a telescope and at least one spacecraft is a starshade. The mission may include observing a number of target stars to detect exoplanets. The system may determine the sequence of spatial configurations based at least in part on the locations of the number of target stars. The trajectory may include a naturally occurring orbit. The trajectory may be further determined according to a time constraint.

In another general aspect, a formation of a number spacecraft has one or more spacecraft configured to receive instructions for causing the number of spacecraft to transition between spatial configurations of the sequence of spatial configurations, including determining periods of fuel-free motion and periods of actuated motion according to a fuel limitation constraint for at least one spacecraft of the number of spacecraft and execute the instructions to cause the number of spacecraft to transition between spatial configurations of the sequence of spatial configurations.

In another general aspect, a method for operating a formation of a number of spacecraft, includes receiving instructions for causing the number of spacecraft to transition between spatial configurations of the sequence of spatial configurations, including determining periods of fuel-free motion and periods of actuated motion according to a fuel limitation constraint for at least one spacecraft of the number of spacecraft and executing the instructions to cause the number of spacecraft to transition between spatial configurations of the sequence of spatial configurations.

In another general aspect, software embodied on a non-transitory, computer readable medium includes instructions for causing one or more spacecraft of a number of spacecraft to receive instructions for causing the number of spacecraft to transition between spatial configurations of the sequence of spatial configurations, including determining periods of fuel-free motion and periods of actuated motion according to a fuel limitation constraint for at least one spacecraft of the number of spacecraft and execute the instructions to cause the number of spacecraft to transition between spatial configurations of the sequence of spatial configurations.

Aspects may have one or more of the following advantages.

Aspects advantageously avoid the use of iterative numerical techniques to solve the equations of motion for the starshade and telescope by using approximate analytical solutions to the circular restricted three-body problem. This is an advantage in computational efficiency because it enables swift execution of scheduling of the telescope and starshade formation in a way that maximizes science yield while minimizing fuel expenditures by exploiting the naturally occurring dynamics.

Other features and advantages of the invention are apparent from the following description, and from the claims.

### BRIEF DESCRIPTION OF THE DRAWINGS

FIG. 1 shows a formation of a telescope and starshade observing a first target star.

FIG. 2 shows the formation retargeting from the first target star to a second target star.

FIG. 3 shows the formation observing the second target star.

FIG. 4 shows the formation retargeting from the second target star to a third target star.

FIG. 5 shows the formation observing the third target star.

FIG. 6 is a mission planning system.

### DETAILED DESCRIPTION

### 1 Overview

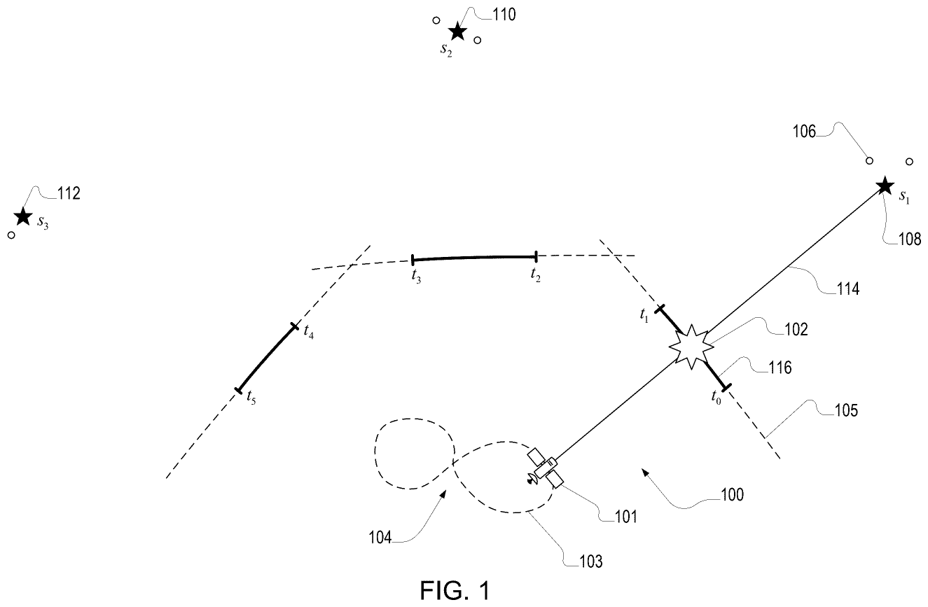

Referring to FIG. 1, a formation 100 of a telescope 101 and a starshade 102 is in orbit around a Lagrange point 104 (e.g., Sun-Earth L2). The telescope is in a halo orbit 103 (shown as having a figure-eight shape but it should be appreciated that other shapes are possible). Very generally, the formation 100 is configured according to a mission plan to identify and characterize exoplanets 106 orbiting around a set of target stars 108, 110, 112 using direct imaging. In some examples, the formation 100 operates in two phases: (1) an imaging phase where a target star is observed and (2) a retargeting phase where the formation positions itself to observe a next target star from the set of target stars 108, 110, 112. Notably, the retargeting phase leverages naturally occurring dynamics about the Lagrange point and the effects of solar radiation pressure to exploit fuel-free motion of the formation 100 during its retargeting.

### 1.1 Imaging Phase

For the telescope 101 to observe exoplanets orbiting a given target star, the formation 100 is positioned such that the starshade 102 causes an artificial eclipse from the viewpoint of the telescope during the imaging phase.

For example, in FIG. 1, the formation 100 is positioned such that a line-of-sight vector 114 is established between the telescope 101 and a first target star 108, s₁. The starshade 102 is positioned between the telescope and the first target star 108, and along the line-of-sight 114. In this configuration of the formation 100, the starshade 102 blocks direct light from the first target star 108 from reaching the telescope 101 while allowing light from the first target star that reflects of the first target star's exoplanets 106 to reach the telescope.

To characterize exoplanets orbiting a target star, the formation 100 needs to collect and integrate images of the exoplanets for a time interval referred to as an imaging time interval. For example, in FIG. 1, a first imaging time interval 116 ranges from time t₀ to time t₁. During the first imaging time interval 116, the telescope 101 moves along the halo orbit 103, and the starshade 102 moves along a different, first orbit 105. The formation 100 is controlled to ensure that the starshade remains on an inertially constant line-of-sight between the telescope and the target star.

### 1.2 Retargeting Phase

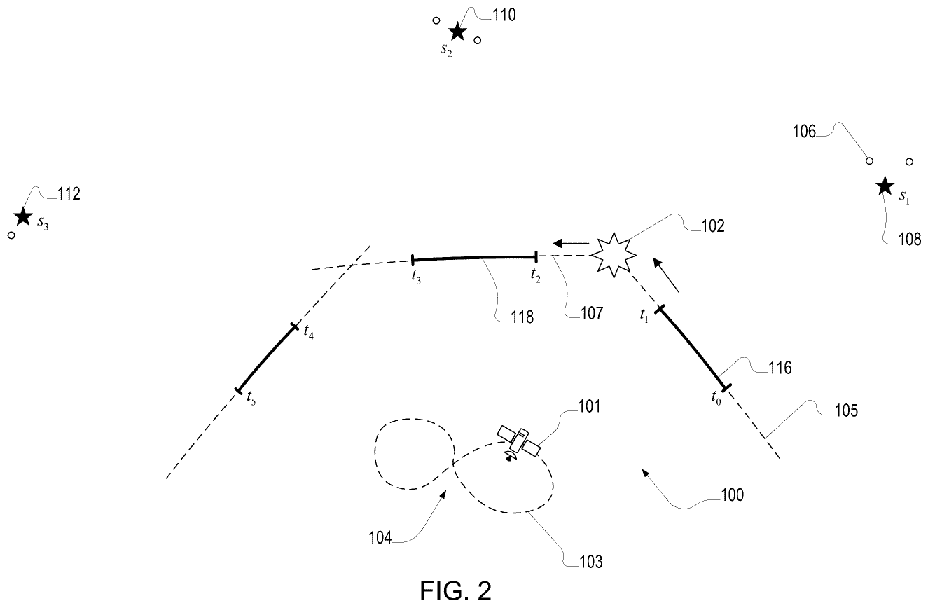

When the formation 100 completes the imaging phase for a target star (i.e., the imaging time interval for the target star elapses), the formation is configured to retarget itself to observe the next target star in the set of target stars before (or just in time for) the next imaging time interval. For example, in FIG. 2, the formation 100 completes its observation of the first target star 108 at time t₁, when the first imaging time interval elapses. The formation 100 then retargets itself in preparation for a second imaging time interval 118 (ranging from time t₂ to t₃) for collecting and integrating images of the corona of a second target star 110, s₂.

Both the start time of the mission and the orbit 103 of the telescope 101 are known. Using that information, a position of the telescope 101 at the beginning of the next imaging interval can be predicted. For example, in FIG. 2, the start time of the mission and the orbit 103 of the telescope 101 can be used to predict or determine a position of the telescope at the beginning of the second imaging time interval 118, t₂. In some examples, the future position of the telescope is calculated using a closed-form approximate analytical solution for the circular restricted three-body problem, CR3BP. Further details regarding determining the telescope position are provided below and details of the CR3BP are included in section 2.5.1 below.

The position of the telescope 101 at the beginning of the next imaging time interval defines a line-of-sight vector between the telescope 101 and the next target star. For example, in FIG. 2, the predicted position of the telescope at the beginning of the second imaging time interval 118, t₂ defines a line-of-sight vector between the telescope and the second target star 110, s₂.

The starshade 102 needs to be positioned between the telescope 101 and the next target star along that line-of-sight by the beginning of the next imaging time interval for observation to occur. For example, in FIG. 2, the starshade needs to be positioned between the telescope 101 and the second target star 110, $2 along the line-of-sight by the beginning of the second imaging time interval 118, t₂ for observation to occur. Repositioning of the starshade 102 is accomplished by determining a new orbit for the starshade 102 that will cause the starshade to arrive in the correct position by the beginning of the second imaging time interval 118, t₂. In some examples, that new orbit is determined using a closed-form approximate analytical solution for the circular restricted three-body problem, CR3BP that also accounts for solar radiation pressure (due to the starshade having characteristics of a light sail). Further details regarding determining the new orbit for the starshade are provided below.

Thrusters on the starshade 102 are then used to position the starshade onto the new orbit, after which it exploits fuel-free motion as it travels to its new position between the telescope 101 and the next target star. For example, in FIG. 2, at some time after time t₁ and before time t₂, the starshade 102 is diverted from the first orbit 105 to a second orbit 107.

### 1.3 Repeat Imaging and Retargeting to Observe all Target Stars

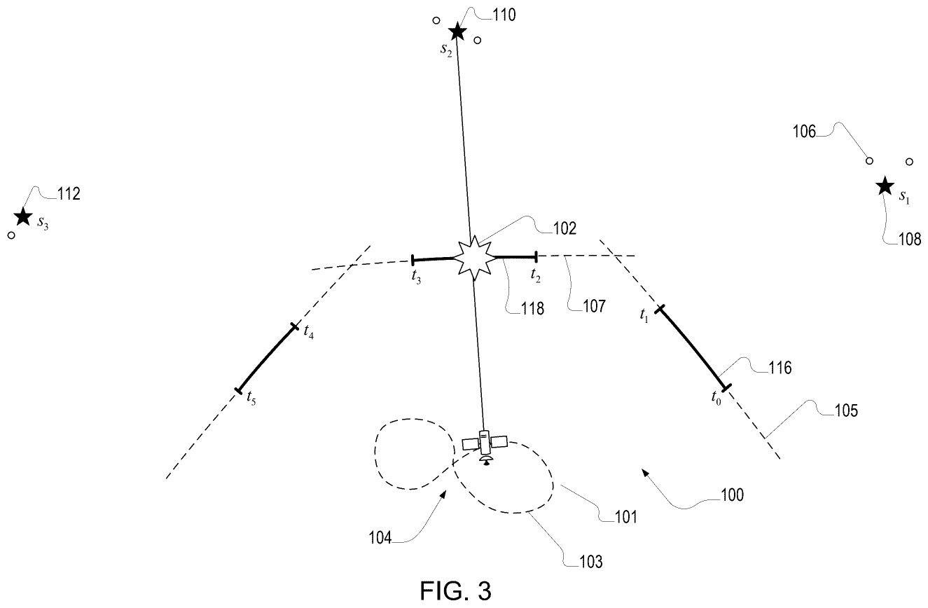

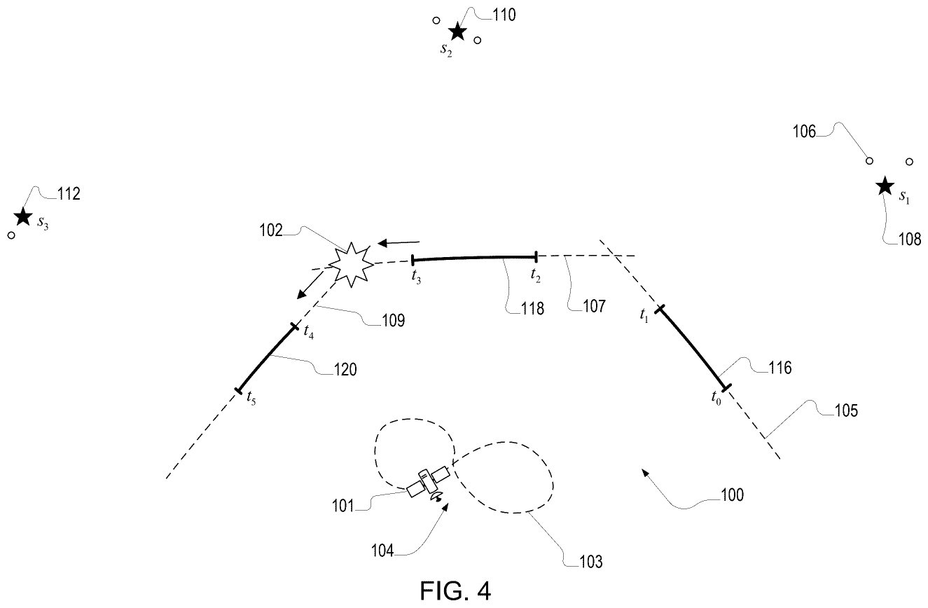

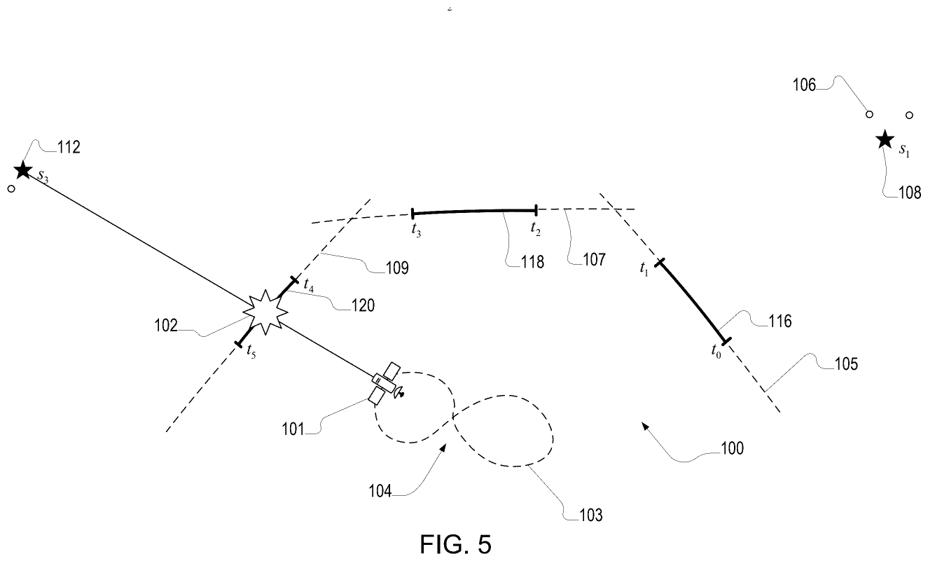

Referring to FIG. 3, the process described above repeats for all the target stars. The second target star 110, s₂ is observed during the second imaging time interval 118. Referring to FIG. 4, after the second imaging time interval 118 elapses, the starshade 102 is retargeted by diverting the starshade from the second orbit 107 to a third orbit 109, which causes the starshade to be positioned between the telescope 101 and a third target star 112, s₃ during a third imaging time interval 120. Referring to FIG. 5, the third target star 112, s₃ is observed during the third imaging time interval 120. This process continues for all target stars.

### 2 Mission Planning System

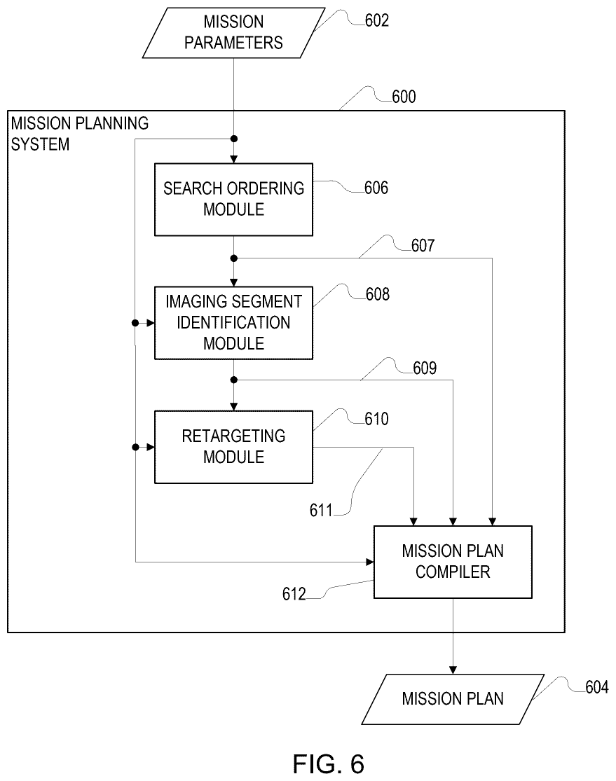

Referring to FIG. 6, a mission planning system 600 receives mission parameters 602 as input and processes the mission parameters to generate a mission plan 604 that causes the formation 100 to observe a set of target stars in the manner described above. In some examples, the mission planning system includes a search ordering module 606, an imaging segment identification module 608, a retargeting module 610, and a mission plan compiler 612.

In some examples, the mission parameters 602 include a target star list, a mission start time, a characterization of the telescope trajectory (i.e., its halo orbit), observability windows for the stars in the target star list, and actuator properties.

### 2.1 Search Ordering Module

The search ordering module 606 processes the mission parameters 602 to determine a search order 607 that specifies an efficient order for observing the target stars using the formation. In some examples, the search ordering module 606 forms a directed acyclic graph with nodes representing observability windows for the target stars and edges representing possible retargeting transitions between target stars. In some examples, the edges are weighted according to some heuristic (e.g., to prefer retargeting transitions to stars that are near each other or optimize to observe as many stars as possible during a given timeframe).

### 2.1.1 Exoplanet Observability Windows

In some examples, the search ordering module 606 first identifies when exoplanets are observable, using orbit characteristics. Some information is available a priori of an exoplanet's orbit around its star that is pertinent for observation scheduling, while the other orbit characteristics can be determined by an internal coronagraph of the telescope. To determine an exoplanet's observability windows for a missions starshade imaging phase, the following information is used: distance to the star, semi-major axis, inclination, eccentricity, time of periastron, position angle of nodes, and the argument of periastron.

In some examples (e.g., during mission scheduling), some or all of that information is unavailable and is either assumed or randomized. For example, exoplanets are assumed to be in circular orbits and their orbital periods are randomly selected from a uniform distribution of values between Venus's period (225 days) and Mars's period (687 days). Then, Kepler's Second Law describing the proportional relationship between orbital period and orbital radius (P₂∝R₃) is used to simulate their orbital radii. Lastly, the position of each exoplanet in its orbit is uniformly randomized at mission time t=0.

This information can be used for determining observability windows because a field of exclusion is produced by the starshade. In accomplishing its task of blocking out light from the exoplanet's star—which enables the ability to directly image the exoplanet—a portion (or the entirety of) the exoplanet's orbit may be excluded.

In some examples, the field of exclusion is treated as a cone emanating from the telescope and the exoplanet's orbit may be thought of as a (potentially inclined) three-dimensional circle. The value of L is the cone's radius at a “height” equivalent to the known star distance D, and is therefore calculated as L=D tan (IWA), where IW A is the small-angle approximation of the starshade's radius and its distance from the telescope. In general, there are three possible relationships that the field of exclusion and the exoplanet's orbit may have:
1. R≤L, indicating the exoplanet's orbit is fully enclosed in the cone no matter its inclination.
2. The orbit is always outside of the field of exclusion.
3. The orbit intersects the cone at four points.

The same equation may be used to determine if an exoplanet falls into either relationship (2) or (3). In some examples, the evaluation of the equation first relies on setting up expressions for the field of exclusion and the orbit. Both are defined with respect to the star as the origin of the coordinate system, with the x-axis in the direction of the telescope to the star. The implicit equation of the cone is:

$${y}^{2} + {z}^{2} = \frac{{L}^{2}}{{D}^{2}} {( x + D )}^{2}$$

The orbit is defined as a three-dimensional circle with inclination i as a set of parametric equations

$$x = R sin i cos ( t )$$

$$y = R sin ( t )$$

$$z = R cos i cos ( t )$$

where t∈[0, 360°]. To find the points of intersection, the parametric equations of the orbit are substituted into the implicit equation of the cone. The resulting quadratic equation is:

$${cos}^{2} ( t ) ( - {R}^{2} {D}^{2} {sin}^{2} i - {L}^{2} {R}^{2} {sin}^{2} i ) - 2 {RDL}^{2} sin i cos ( t ) + {R}^{2} {D}^{2} - {L}^{2} {D}^{2} = 0$$

from which the roots of the equation can be found.

$$cos ( t ) = \frac{- {DL}^{2} \pm D \sqrt{{D}^{2} {R}^{2} - {D}^{2} {L}^{2} + {L}^{2} {R}^{2}}}{R sin i ( {D}^{2} + {L}^{2} )}$$

Therefore, the two possible roots of cos (t) can produce two of the intersection points by solving for t and substituting the values into the parametric equations of the orbit. Having done so, each value can be subtracted from 360° to find the other two values of t corresponding to the symmetric intersecting points. However, if

$$\vert \frac{- {DL}^{2} \pm D \sqrt{{D}^{2} {R}^{2} - {D}^{2} {L}^{2} + {L}^{2} {R}^{2}}}{R sin i ( {D}^{2} + {L}^{2} )} \vert > 1$$

that indicates the orbit is always outside of the cone of exclusion and is therefore always observable.

In some examples (e.g., prior to the mission's coronograph phase), it is assumed every exoplanet has an inclination of 90° with respect to the LOS vector. This is the edge-on case and is a worst-case scenario assumption. In some examples, certain exoplanets are never observable with the aforementioned randomization, meaning that the orbital radius is less than L=D tan(IWA). Additionally, the observability windows shorten as the exoplanet number increases. This is a feature of how the target stars are organized (i.e., the target star list is organized by ascending distance). As a result, L becomes larger, making it more likely to be greater than the exoplanet's randomized orbital radius. Generally, the observability windows increase as the inclination decreases.

One important consideration in scheduling imaging for a space-based telescope is the position of bright bodies whose light may saturate the telescope's pupil. Nominally, a minimum angle is defined relative to the telescope's pointing vector and the relative position of the bright body. However, since the starshade is effectively a large reflective surface, an additional maximum angle is applied to avoid light reflecting off the starshade into the telescope's pupil. In this manner, “keepout zones” may be defined with respect to each bright body for each moment in time.

The Sun, Earth, and Moon are the most significant bright bodies to consider for the telescope/starshade formation flying problem at Sun-Earth L2. The equation defining the keepout angle between the bright body and the target star is defined via their relative positions to the telescope. Namely,

$$cos {κ}_{B} = {\hat{r}}_{B / T} \cdot {\hat{r}}_{i / T}$$

where κ_{B} is the minimum or maximum keepout angle, T is the telescope, i is the target star, and B is the bright body (where B∈[S, E, M]).

One method of approaching the bright body avoidance problem is by finding a binary keepout map that indicates when each star is observable for some length of time. When scheduling observations, this binary keepout map is cross-checked with respect to a pre-defined telescope trajectory to determine if a star was observable at the selected time. The approach used herein is similar in that a pre-defined telescope trajectory is evaluated. However, for each star at each point in time of the mission, it is determined if the telescope is outside of the star's keepout zone with respect to the bright bodies. If so, then it is checked if the randomized exoplanet orbit is observable. When both requirements are satisfied for a window of time that exceeds the star's required imaging time, that time window is recorded as observable for the exoplanet around the target star.

### 2.1.2 Star Order Selection

With the exoplanet observability windows determined, the search order 607 is determined. In some examples, selecting the star order for a specific time window in the mission requires knowledge of the last star observed in the previous time window, the angular separation of all stars, the available time windows for observation for each star, and the fixed retargeting maneuver time, indicated as ΔtRT. The star order selection methodology makes use of graph theory and the maximal path algorithm for a directed acyclic graph.

For example, the problem is designed as a multi-directed graph where the nodes correspond to stars' observation time windows. In this manner, a star may have multiple nodes if it has multiple observation time windows within the specific time window of the mission currently being processed. The observation time windows for star i are denoted by their initial and terminal times only, such that

$${t}_{obs}^{i} = [ {t}_{obs , initial}^{i} , {t}_{obs , terminal}^{i} ] .$$

In this graph, the edges between nodes are defined when the terminal of one window for star (node) i is less than the last possible start of imaging in a window for star (node) j and when the angular separation between the two stars is positive. The last possible start of imaging in a window is calculated as

$${t}_{start , latest}^{j} = {t}_{obs}^{j} ( 2 ) - Δ {t}_{RT} - Δ {t}_{imaging}^{j}$$

Where Δt_{imaging}^{j} is the required imaging time for the star j. For finding the angular separations between stars, the following formula is used to calculate the separation from star i to star j

$$ψ = h {cos}^{- 1} ( {\hat{r}}_{i / 𝒪} \cdot {\hat{r}}_{j / 𝒪} )$$

where h=1 if the right ascension of star i is greater than 180° and the right ascension of star j is less than 180°. Otherwise, h=sgn(RAⱼ−RAᵢ), where RA indicates right ascension. When the conditions

$${t}_{start , latest}^{j} \geq {t}_{obs}^{i} ( 2 )$$

$$and$$

$$ψ \geq 0 °$$

are satisfied, a directed edge is formed between node i and node j.

Each directed edge is weighed using a custom weight function. The primary weight function considers the angular separation between the two stars associated with the two nodes of an edge. Namely, it calculates the inverse of the angular separation, such that the stars with the smaller separations will have more favorable weights. This metric is used for the weight function because it serves as an analog for fuel efficiency during retargeting. In this manner, it is observed that using the inverse of angular separation for weights yields a maximal path for a mission that performs more fuel optimally than the case where no weights are used. Additional heuristics that may be used in a custom weight function include:
1. Rarity of observation: weigh more heavily the stars that are available for observation the least amount of times in a mission
2. Valuableness of observation: prioritize observing stars that fulfill a user-defined valuableness such as stars closest to Earth
3. Tightness of observability windows:

$$( {t}_{obs , terminal}^{i} - {t}_{start , latest}^{j} )$$

These heuristics may be considered separately or as additive weights with each other or the inverse of angular separation. In some examples, the inverse of angular separation is used as the sole weight on the directed edges.

Since this star order methodology is applied to discrete segments of the mission at a time, it may be necessary to stitch together two segments forcefully. This is achieved by passing the last star from the previous segment and forcing it to be the most highly weighted node to all stars it naturally would lead to. Thus, the only differentiation from the logic above is an artificial addition of a factor of 100 to its weight function. This guarantees that the last star from the previous segment is selected as the first star of the current segment and that therefore, all following stars are the most fuel-optimal choices (fuel-optimal as best determined via the angular separation weight function).

One of the primary reasons for separating the star order methodology across several mission time windows is to limit the occurrences of a directed cyclic graph. The longest path algorithm only works for acyclic graphs, and the nature of the edge creation for this application lends itself to cyclic graphs if the whole mission is considered. While using smaller mission time windows prevents most cases of cyclic graphs, it is still necessary to account for them algorithmically. One method for breaking a cyclic graph is to find the most central node of the most strongly connected subgraph and remove the edge with the lowest weight (therefore having the least impact on finding the “best” star order). This can be applied repeatedly until the graph is acyclic. Having established a directed acyclic graph for a discrete time window in the mission, the longest path algorithm may be employed to yield the search order 607.

### 2.2 Imaging Segment Identification Module

The imaging segment identification module 608 processes the search order 607 and the mission parameters 602 to identify imaging segments 609 (e.g., the imaging time intervals 116, 118, 120 described above) for observing the target stars according to the search order 607. In general, the target stars are observable in their respective observability windows, but it is not necessarily feasible for the formation to be positioned to observe a given star at the beginning of its observability window (e.g., the starshade might not be able to arrive in time). The imaging segment identification module 608 identifies imaging segments 609 that are feasible in the observability windows of the target stars, given the search order (sometimes referred to as a “coarse” retargeting optimization).

In general, the algorithm for finding imaging segments occurs after finding the star order list for each time window segment of a mission. In this manner, it may require knowledge of the star order and the stars' associated time windows for observation. It also keeps track of the global mission time and the halo orbit time for the telescope.

For each star, the global mission time is calculated based on the completion of imaging for the previous star plus the minimum time for retargeting. The corresponding halo orbit time is tracked and incremented, as well, using the non-dimensional time characteristic of the CR3BP. Using the approximate analytical solutions for the CR3BP (described in greater detail below in section 2.5), the characteristic amplitude (e.g., A_{z}=335,000 km), and the halo orbit time, the telescope's position in the rotating frame at the start of the imaging segment for a star is determined. Given the telescope's position and using the transformation from the rotating frame to the inertial frame, the required position for the starshade is calculated in the inertial frame. After transforming the starshade's position back to the rotating frame, a coarse retargeting optimization is executed to determine if the starshade can maneuver from its state at the end of the last imaging segment to the currently calculated starshade position in the current time duration without saturating its thruster. If the optimization yields a failure status, this function increments the mission time by a day, finds the updated telescope position, and calculates the new desired starshade position. This occurs until the retargeting maneuver is achievable or the

$${t}_{start , latest}^{j}$$

is exceeded.

Once a suitable desired starshade position is calculated, its position relative to the Sun and the target star's position relative to the telescope enable the determination of the starshade's attitude angles α and γ. Given the starshade's attitude angles and its desired position in the rotating frame, the quasi-periodic orbit coincident with that position in space is identified using the techniques described below in section 2.5. If it fails to find the characteristic amplitudes and time corresponding to the inputted position, two avenues may be pursued before incrementing the mission time and beginning the process again.

The first avenue is to pass a nonzero value to the multiplier m, which translates the range of time considered in the orbit identification search by m periods. When a₃ and a₄ are both nonzero, the circular restricted three body problem with solar radiation pressure (CR3BP with SRP) trajectory is quasi-periodic. Therefore, the multiplier m allows for searching across a new period in the quasi-periodic trajectory (i.e. a new revolution). This may be executed a user-defined number of times, exiting when an orbit is identified or the limit of the search is exceeded.

If this first avenue for expanded orbit identification fails, a secondary avenue takes advantage of the axial tolerance of, for example, ±250 km. The desired position of the starshade is recalculated as the separation distance d and a fraction of the axial tolerance away from the telescope along the LOS to the target star. In some examples, this avenue is limited to only consider, for example ±50 km and ±100 km, as a greater fraction of the axial tolerance often fails the separation distance verification check. If this also fails to identify a characteristic orbit and position, the algorithm increments the mission time and starts the process of finding the starshade position again.

When the orbit and position identification is successful, the actual starshade position must be verified to be within the axial tolerance of the required separation distance to the telescope. Using the actual starshade position, its position relative to the telescope is calculated. If the norm of the relative position is within, for example, [d−250, d+250] km, a secondary check verifies the difference between the desired and actual starshade positions is less than, for example, 250 km in each coordinate. If either check fails, the actual starshade position is rejected, the mission time is incremented by a day, and the process begins again. When the two checks are passed, a valid starshade position at the start of the imaging segment has been determined. The final starshade position at the terminus of the imaging segment (defined by the required imaging time) is sought via the same process, with the exclusion of the coarse retargeting optimization. Once an imaging segment has been determined, the pertinent orbit information is saved, and the algorithm proceeds to the next star by incrementing by the minimum retargeting time.

### 2.2.1 Estimating Fuel Costs During Imaging

In some examples, fuel costs are estimated to account for adjustments required of the starshade to maintain the LOS. The LOS requirement imposes a desired (des) starshade position with respect to the telescope position by separation distance d.

$${r}_{des / T} = d \frac{{r}_{i / T}}{\vert {r}_{i / T} \vert}$$

The actual starshade position is denoted as r_{SS/T} and [symbol] . To find how the starshade position differs from its desired position, compute the following:

$${r}_{SS / des} = {r}_{SS / 𝒪} - {r}_{T / 𝒪} - {r}_{T / des}$$

Differentiating twice in the inertial frame to find the acceleration yields

$${}^{𝒥} {a}_{SS / des} = {}^{𝒥} {a}_{SS / 𝒪} - {}^{𝒥} {a}_{T / 𝒪} - {}^{𝒥} {a}_{T / des}$$

where [symbol] is the parallax correction term, which is very small for observations outside of the solar system. Since [symbol] ≈0 compared to [symbol] and gar [symbol] , it is ignored. Now, [symbol] is the disturbance acceleration on the starshade during imaging.

The disturbance that must be accounted for during imaging is estimated by taking [symbol] (t_{f}) and the initial mass of the starshade at the beginning of imaging.

$$Δ F = {m}_{SS} ( {t}_{0} ) {}^{𝒥} {a}_{SS / des} ( {t}_{f} )$$

The disturbance in the axial direction of imaging is

$$Δ {F}_{ax} = Δ F \cdot \frac{{r}_{i / T}}{\vert {r}_{i / T} \vert}$$

and the lateral disturbance is

$$Δ {F}_{lat} = \vert Δ F - Δ {F}_{ax} \frac{{r}_{i / T}}{\vert {r}_{i / T} \vert} \vert$$

The lateral disturbance force is used to estimate the mass flow rate, the fuel mass used, and the ΔV for imaging.

$$\begin{matrix}{\dot{m}}_{SS} = \frac{Δ {F}_{lat}}{{I}_{sp} {g}_{0}} \\ {m}_{SS} ( {t}_{f} ) = {\dot{m}}_{SS} ( {t}_{f} - {t}_{0} ) \\ Δ V = {I}_{s p} {g}_{0} ln \frac{{m}_{S S} ( {t}_{0} )}{{m}_{S S} ( {t}_{f} )}\end{matrix}$$

### 2.3 Retargeting Module

The retargeting module 610 processes the imaging segments 609 and the mission parameters 602 to determine retargeting instructions 611 for efficiently retargeting the formation 100 according to the search order 607 and the imaging segments 609. As is described above, based on the imaging segment determination, the retargeting module 610 determines an orbital adjustment for the starshade 102 that causes the starshade to arrive in the right place at the right time for the next imaging segment while exploiting fuel-free travel.

The retargeting optimization is executed after the completion of the loop of discrete time segments of the mission over the two aforementioned functionalities. The optimization for each retargeting maneuver is executed between the starshade's terminal state at imaging segment

$$i , ( {X}_{S S}^{i} ( {t}_{f} ) )$$

and its required starting state at imaging segment

$$i + 1 ( {X}_{SS}^{i + 1} ( {t}_{0} ) )$$

Therefore, the optimization solves a two-point boundary value problem with a fixed final time via the constrained minimum-fuel optimal control problem:

$${min}_{{u}_{thrust}} J ( {u}_{thrust} ) = {\int }_{{t}_{0}}^{{t}_{f}} \vert {u}_{x} ( t ) \vert + \vert {u}_{y} ( t ) \vert + \vert {u}_{z} ( t ) \vert dt$$

subject to

$$\begin{matrix}\dot{x} ( t ) = f ( x , u ) \\ \begin{matrix}- {u}_{max} \leq {u}_{q} \leq {u}_{max} , & q ∈ [ x , y , z ]\end{matrix} \\ \begin{matrix}{t}_{0} = {T}_{i} , & {t}_{f} = {T}_{i + 1} , & x ( {t}_{0} ) = {X}_{S S}^{i} ( {t}_{f} ) , & x ( {t}_{f} ) = {X}_{S S}^{i + 1} ( {t}_{0} )\end{matrix}\end{matrix}$$

where u is the control input and x is the state vector. The dynamics of the optimization are constrained to the CR3BP with SRP, described below in section 2.5. Since the SRP acceleration of the starshade is modeled in the dynamics, it is permitted to act as a tool of actuation rather than a perturbation to be corrected. During retargeting, there are no attitude requirements placed on the starshade, so in the optimization of the retargeting maneuver, the starshade's attitude angles are allowed to vary, acting as additional control inputs. Therefore, consider the control input vector

$$u ( t ) = [ \begin{matrix}α ( t ) \\ γ ( t ) \\ {u}_{thrust} ( t )\end{matrix} ] .$$

It has been shown that an optimization in the restricted three-body problem with no knowledge of invariant manifolds will converge to low-thrust trajectories that use invariant manifolds. Therefore, it is anticipated that the resulting retargeting maneuvers from this optimization will make use of the manifolds when sufficient retargeting time is permitted. Namely, this behavior is anticipated to occur in the free drift interval of the time histories that closely approach a bang-off-bang control scheme.

Note that the coarse execution of the retargeting optimization during the imaging segment identification described above uses only ten steps to provide a quick answer if the retargeting maneuver is feasible. During the proper retargeting optimization that occurs after all the imaging segments are identified, 1,000 time steps are used. Using these two levels of resolution permits a more adaptive retargeting time during imaging segment identification. In some examples, a minimum retargeting time of 10 days was satisfactory for all retargeting maneuvers. However, in some transfers, this results in excessive time retargeting. By employing this adaptive retargeting time scheme, a balance may be struck between fuel and time without explicitly optimizing for time.

Note that the estimated fuel costs during imaging to maintain the formation LOS occur between the retargeting optimizations. These estimates may occur sequentially so that the starshade's total mass is properly decremented. The proper tracking of the starshade's total mass leads to more efficient fuel usage during the retargeting maneuvers.

### 2.3.1 Thruster Modeling for Retargeting

In some examples, the starshade has a hybrid propulsion system. The bipropellant chemical system is used for trajectory correction maneuvers, station-keeping, and slewing. The solar electric propulsion (SEP) system is used for retargeting.

For the SEP thrusters, the modeling assumes that the thrusters are oriented for full positional control, such that each thruster is uniquely responsible for a single direction (+x, −x, +y, −y, +z, and −z in the starshade's body frame). Consider the following thruster equation

$${u}_{thrust} ( t ) = \frac{{T}_{max}}{{m}_{ss} ( t )} [ \begin{matrix}{u}_{x} \\ {u}_{y} \\ {u}_{z}\end{matrix} ]$$

where Tₘₐₓ is the non-dimensionalized thruster force, mₛₛ(t) is the non-dimensionalized time-varying mass of the starshade, uₓ∈[−1, 1], u_{y}∈[−1, 1], and u_{z}∈[−1, 1]. Additionally, the starshade's mass flow rate is

$${\dot{m}}_{ss} ( t ) = - \frac{{T}_{max}}{{I}_{sp} {g}_{0}} ( \vert {u}_{x} \vert + \vert {u}_{y} \vert + \vert {u}_{z} \vert )$$

where g₀ is the standard gravitational acceleration. Finally, the amount of ΔV required for retargeting per maneuver is calculated via

$$Δ V = {I}_{sp} {g}_{0} ln ( \frac{{m}_{ss} ( {t}_{0} )}{{m}_{ss} ( {t}_{\text{?}} )} ) .$$

$$\text{?} \text{indicates text missing or illegible when filed}$$

For integration into the retargeting optimization, it is necessary to non-dimensionalize the starshade's mass and the maximum thrust magnitude since non-dimensionalized dynamics are used in the CR3BP with SRP. Using the mass parameter (m₁+m₂) to non-dimensionalize the starshade's mass can result in numerical issues since the non-dimensionalized value would be extremely small. To avoid numerical issues, the starshade's mass is non-dimensionalized by its initial wet mass. Moreover, the maximum thrust magnitude is non-dimensionalized using the previously defined distance and time parameters and the starshade's initial wet mass.

### 2.4 Mission Plan Compiler

The mission plan compiler 612 processes the search order 607, imaging segments 609, retargeting instructions 611, and mission parameters 602 to form the mission plan 604. In some examples, the mission plan 604 is formed on Earth and is loaded onto the telescope 101 and/or starshade 102, which execute the mission plan 604 (e.g., as software executing on a computing system in the spacecraft) after being launched and positioned near the Lagrange point. In other examples, the mission plan 604 can be transmitted to the telescope and/or starshade from Earth (either as a full computer program or as individual instructions for controlling the telescope and/or starshade).

### 2.5 Orbit Identification Using Approximate Analytical Solutions

As is described above, approximate analytical solutions to the CR3BP and the CR3BP with SRP are used to trace between positions in space and characteristic orbits at characteristic times on those orbits. Details of those approximate analytical solutions are described in this section.

### 2.5.1 CR3BP

The CR3BP is a dynamical model of the motion of a small mass P₃ under the influence of gravity of two large celestial bodies (P₁ and P₂). The model assumes that

$${m}_{1} > {m}_{2} >> {m}_{3} ,$$

P₁ and P₂ rotate around their barycenter in a coplanar, circular path,
the system uses a rotating coordinate system with its origin at barycenter,
the dynamics are non-dimensionalized,
the mass parameter,

$$μ = \frac{{m}_{2}}{{m}_{1} + {m}_{2}} ,$$

and
the system is conservative and Hamiltonian.

The equations of motion for the CR3BP are defined as:

$$\ddot{x} - 2 \dot{y} = x - \frac{( 1 - μ ) ( x + μ )}{{r}_{1}^{3}} - \frac{μ ( x + μ - 1 )}{{r}_{2}^{3}} = \frac{\partial U}{\partial x}$$

$$\ddot{y} + 2 \dot{x} = y - \frac{y ( 1 - μ )}{{r}_{1}^{3}} - \frac{y μ}{{r}_{2}^{3}} = \frac{\partial U}{\partial y}$$

$$\ddot{z} = - \frac{z ( 1 - μ )}{{r}_{1}^{3}} - \frac{z μ}{{r}_{2}^{3}} = \frac{\partial U}{\partial z}$$

$${r}_{1} = \sqrt{{( x + μ )}^{2} + {y}^{2} + {z}^{2}}$$

$${r}_{2} = \sqrt{{( x + μ - 1 )}^{2} + {y}^{2} + {z}^{2}}$$

### Potential Function:

$$U = \frac{1}{2} ( {x}^{2} + {y}^{2} ) + \frac{1 - μ}{{r}_{1}} + \frac{μ}{{r}_{2}}$$

### Jacobi Integral (Energy Analog):

$$C = 2 ( \frac{1 - μ}{{r}_{1}} + \frac{μ}{{r}_{2}} ) + ( {x}^{2} + {y}^{2} ) - ( {\dot{x}}^{2} + {\dot{y}}^{2} + {\dot{z}}^{2} )$$

No closed-form, analytical solution exists for these equations of motion. In general, the equations of motion yield five equilibrium (Lagrange/libration) points, where Sun-Earth L2 is the equilibrium point of interest for the telescope/starshade formation flying problem.

Numerically identifying periodic orbits using the equations of motion typically requires a highly precise initial condition, or a good initial condition guess (e.g., Richardson's method) that is refined by a differential correction scheme. Alternatively, perturbation theory can be used to find a closed-form, approximate analytical solution for periodic orbits. To do so, the equivalent equations of motion about Sun-Earth L2 are determined as:

$$\ddot{\overline{x}} - 2 \dot{y} - ( 1 + 2 {c}_{2} ) \overline{x} = {\sum }_{n \geq 2} {c}_{n + 1} ( n + 1 ) {T}_{n}$$

$$\ddot{y} + 2 \dot{\overline{x}} + ( {c}_{2} - 1 ) y = y {\sum }_{n \geq 2} {c}_{n + 1} {R}_{n - 1}$$

$$\ddot{z} + {c}_{2} z = z {\sum }_{n \geq 2} {c}_{n + 1} {R}_{n - 1}$$

Based on the equivalent equations of motion, the closed-form analytical solution to model CR3BP halo orbits can be found by determining the coordinate and frequency series of the form:

$$\overline{x} ( t , {A}_{x} , {A}_{z} ) = {\sum }_{i , j = 1}^{∞} ( {\sum }_{k \leq i + j} {x}_{i j k} cos ( k θ ) ) {A}_{x}^{i} {A}_{z}^{j}$$

$$y ( t , {A}_{x} , {A}_{z} ) = {\sum }_{i , j = 1}^{∞} ( {\sum }_{k \leq i + j} {y}_{i j k} sin ( k θ ) ) {A}_{x}^{i} {A}_{z}^{j}$$

$$z ( t , {A}_{x} , {A}_{z} ) = {\sum }_{i , j = 1}^{∞} ( {\sum }_{k \leq i + j} {z}_{i j k} cos ( k θ ) ) {A}_{x}^{i} {A}_{z}^{j}$$

$$where$$

$$θ = ω t + ϕ$$

$$and$$

$$ω = {\sum }_{i , j = 0}^{∞} {ω}_{ij} {A}_{x}^{i} {A}_{z}^{j} , Δ = {\sum }_{i , j = 0}^{∞} {d}_{ij} {A}_{x}^{i} {A}_{z}^{j} = 0.$$

For example, the system of equations described above is solved with the goal of finding coefficients of nth order using solutions from n−1. This is done by first initializing the process using the general solution (n=1) and then using the series-substituted equations of motion to form a system of equations where known solutions (n−1) are used on the right-hand side. The result is a user-defined nth-order solution expecting inputs of (t, Aₓ, A_{z}) where Aₓ is a function of A_{z}.

2.5.2 CR3BP with SRP

The CR3BP with SRP is a dynamical model of a small mass P₃ under the influence of gravity of two large celestial bodies (P₁ and P₂) and solar radiation pressure (SRP). The model assumes that.

$${m}_{1} > {m}_{2} >> {m}_{3} ,$$

P₁ and P₂ rotate around their barycenter in a coplanar, circular path,
the system uses a rotating coordinate system with its origin at barycenter,
the dynamics are non-dimensionalized,
the mass parameter,

$$μ = \frac{{m}_{2}}{{m}_{1} + {m}_{2}} ,$$

and
the system is generally non-conservative and non-Hamiltonian.

The equations of motion for the CR3BP with SRP are defined as:

$$\ddot{x} - 2 \dot{y} = x - \frac{( 1 - μ ) ( x + μ )}{{r}_{1}^{3}} - \frac{μ ( x + μ - 1 )}{{r}_{2}^{3}} + {a}_{SRP , x} = \frac{\partial U}{\partial x} + {a}_{SRP} \cdot \hat{x}$$

$$\ddot{y} + 2 \dot{x} = y - \frac{y ( 1 - μ )}{{r}_{1}^{3}} - \frac{y μ}{{r}_{2}^{3}} + {a}_{SRP , y} = \frac{\partial U}{\partial y} + {a}_{SRP} \cdot \hat{y}$$

$$\ddot{z} = - \frac{z ( 1 - μ )}{{r}_{1}^{3}} - \frac{z μ}{{r}_{2}^{3}} + {a}_{SRP , z} = \frac{\partial U}{\partial z} + {a}_{SRP} \cdot \hat{z}$$

$$where$$

$${r}_{1} = \sqrt{{( x + μ )}^{2} + {y}^{2} + {z}^{2}} , {r}_{2} = \sqrt{{( x + μ - 1 )}^{2} + {y}^{2} + {z}^{2}}$$

$${a}_{SRP} = β \frac{1 - μ}{{r}_{1}^{2}} {( {\hat{r}}_{1} \cdot n )}^{2} n$$

$$n = cos ( α ) {\hat{r}}_{1} + sin ( α ) sin ( γ ) \frac{{\hat{r}}_{1} \times \hat{z}}{\vert {\hat{r}}_{1} \times \hat{z} \vert} + sin ( α ) cos ( γ ) \frac{( {\hat{r}}_{1} \times \hat{z} ) \times {\hat{r}}_{1}}{\vert ( {\hat{r}}_{1} \times \hat{z} ) \times {\hat{r}}_{1} \vert}$$

### Potential Function:

$$U = \frac{1}{2} ( {x}^{2} + {y}^{2} ) + \frac{1 - μ}{{r}_{1}} + \frac{μ}{{r}_{2}}$$

As was the case with the CR3BP above, no closed-form, analytical solution exists for these equations of motion. In general, the equations of motion yield four to five artificial equilibrium points (AEPs).

Because the system is non-Hamiltonian, there is no guarantee that dense families of periodic orbits will exist around the AEPs, but periodic, nearly periodic, and quasi-periodic orbits are discoverable (where information provided by the Jacobi integral reveals information about periodicity). Again, numerically identifying periodic orbits using the equations of motion typically requires a highly precise initial condition, or a good initial condition guess (e.g., Richardson's method) that is refined by a differential correction scheme. Even so, the process may yield no solution because there is no guarantee of dense families of periodic orbits. Alternatively, perturbation theory can be used to find a closed-form, approximate analytical solution for periodic (or nearly periodic) orbits. To do so, the equivalent equations of motion about Sun-Earth L2 are determined as:

$$\ddot{\overline{x}} - 2 \dot{\overline{y}} - {U}_{x x}^{*} \overline{x} - {U}_{x y}^{*} \overline{y} - {U}_{xz}^{*} \overline{z} = \frac{1}{{\vert Γ \vert}^{3}} ( \frac{\partial G}{\partial \overline{x}} + {a}_{SRP , {x}^{\text{?}}} {\vert}_{n = 0} + {a}_{SRP , {x}^{\text{?}}} {\vert}_{n \geq 2} + {\sum }_{n \geq 3} [ \frac{1 - μ}{{D}_{1}} {R}_{n}^{{x}^{\text{?}} , 1} + \frac{μ}{{D}_{2}} {R}_{n}^{{x}^{\text{?}} , 2} ] )$$

$$\ddot{\overline{y}} + 2 \dot{\overline{x}} - {U}_{yx}^{*} \overline{x} - {U}_{yy}^{*} \overline{y} - {U}_{yz}^{*} \overline{z} = \frac{1}{{\vert Γ \vert}^{3}} ( \frac{\partial G}{\partial \overline{y}} + {a}_{SRP , {y}^{\text{?}}} {\vert}_{n = 0} + {a}_{SRP , {y}^{\text{?}}} {\vert}_{n \geq 2} + {\sum }_{n \geq 3} [ \frac{1 - μ}{{D}_{1}} {R}_{n}^{{y}^{\text{?}} , 1} + \frac{μ}{{D}_{2}} {R}_{n}^{{y}^{\text{?}} , 2} ] )$$

$$\ddot{\overline{z}} - {U}_{zx}^{*} \overline{x} - {U}_{zy}^{*} \overline{y} - {U}_{z z}^{*} \overline{z} = \frac{1}{{\vert Γ \vert}^{3}} ( \frac{\partial G}{\partial \overline{z}} + {a}_{SRP , {z}^{\text{?}}} {\vert}_{n = 0} + {a}_{SRP , {z}^{\text{?}}} {\vert}_{n \geq 2} + {\sum }_{n \geq 3} [ \frac{1 - μ}{{D}_{1}} {R}_{n}^{{z}^{\text{?}} , 1} + \frac{μ}{{D}_{2}} {R}_{n}^{{z}^{\text{?}} , 2} ] )$$

$$\text{?} \text{indicates text missing or illegible when filed}$$

Based on the equivalent equations of motion, the closed-form analytical solution to model CR3BP with SRP orbits can be found by determining the coordinate and frequency series of the form:

$$\overline{x} ( t , μ , β , α , γ ) = \sum {e}^{( i - j ) {θ}_{3}} ( {x}_{ijkm}^{p q} cos ( p {θ}_{1} + q {θ}_{2} ) + {\tilde{x}}_{ijkm}^{pq} sin ( p {θ}_{1} + q {θ}_{2} ) ) {a}_{1}^{i} {a}_{2}^{j} {a}_{3}^{k} {a}_{4}^{m}$$

$$\overline{y} ( t , μ , β , α , γ ) = \sum {e}^{( i - j ) {θ}_{3}} ( {y}_{ijkm}^{p q} cos ( p {θ}_{1} + q {θ}_{2} ) + {\tilde{y}}_{ijkm}^{p q} sin ( p {θ}_{1} + q {θ}_{2} ) ) {a}_{1}^{i} {a}_{2}^{j} {a}_{3}^{k} {a}_{4}^{m}$$

$$\overline{z} ( t , μ , β , α , γ ) = \sum {e}^{( i - j ) {θ}_{3}} ( {z}_{ijkm}^{pq} cos ( p {θ}_{1} + q {θ}_{2} ) + {\tilde{z}}_{ijkm}^{pq} sin ( p {θ}_{1} + q {θ}_{2} ) ) {a}_{1}^{i} {a}_{2}^{j} {a}_{3}^{k} {a}_{4}^{m}$$

$$ω = \sum {ω}_{ijkm} {a}_{1}^{i} {a}_{2}^{j} {a}_{3}^{k} {a}_{4}^{m} , v = \sum {v}_{ijkm} {a}_{1}^{i} {a}_{2}^{j} {a}_{3}^{k} {a}_{4}^{m} , λ = \sum {λ}_{ijkm} {a}_{1}^{i} {a}_{2}^{j} {a}_{3}^{k} {a}_{4}^{m}$$

$$where {θ}_{1} = ω t + {ϕ}_{1} , {θ}_{2} = v t + {ϕ}_{2} , {θ}_{3} = λ t .$$

For example, the system of equations described above is solved with the goal of finding coefficients of nth order using solutions from n−1. This is done by first initializing the process using the general solution (n=1) and then using the series-substituted equations of motion to form a system of equations where known solutions (n−1) are used on the right-hand side. The result is a user-defined nth-order solution expecting inputs of (t, μ, β, α, γ).

### 2.5.3 Starshade Orbital Segment Identification

Given a telescope position on a halo orbit, the required state of the starshade is deduced by using the required separation distance between the two spacecraft (e.g., 76,600 km) along the LOS to the target star. Then the quasi-periodic orbit that the starshade coincides with or is in proximity to is determined after finding its position in the rotating frame. This process uses the approximate solutions for the CR3BP with SRP described above to trace from a position in space to a characteristic orbit and characteristic time on that orbit.

For the starshade, it is necessary to trace from a position in space (x₁, y₁, z₁) to the characteristic orbit and position demarcated by (a₃, a₄, t). In some examples, for computational efficiency, the third-order approximate solutions are used. The algorithm that performs this tracing operates as follows.
1: Initialize ranges of a₃, a₄, and t to search over. For example, the following ranges are used:

$$0 \leq {a}_{3} \leq 0 \text{.20}$$

$$- 0.2 \; 0 \leq {a}_{4} \leq 0.20$$

$$0 + 3.2 m \leq t \leq 1.8 + 3.2 m when {y}_{1} \leq 0 ,$$

$$1.4 + 3.2 m \leq t \leq 3.2 + 3.2 m when {y}_{1} > 0$$

where m is a user-inputted multiplier that helps consider more than the initial revolution of a quasi-periodic trajectory. Nominally, m is an integer that may be positive or negative. The ranges for the amplitudes a₃ and a₄ correspond to the upper bounds of the domains of practical convergence₂. Generally, a single revolution of a Lissajous-like trajectory is π non-dimensional time units, which is rounded up to 3.2. Additionally, positive y₁ values correspond to the second half of a trajectory while negative values correspond to the first half of the trajectory. To account for the generalization of the (quasi-) period of a revolution, the time ranges associated with positive and negative y₁ values are overlapped rather than strictly split in half.
2: Create an outermost for loop that keeps track of a user-defined iteration limit for the search. At this level, the ranges for a₃, a₄, and t are discretized to 50 linearly spaced values in their initial ranges.
3: Create a triple-nested for loop, where, at each level, a value for a₃, a₄, and t is selected. For each unique combination, the third-order approximate solution is evaluated. The position error norm is identified between this solution and the position (x₁, y₁, z₁). If the position error norm is smaller than the previously recorded smallest error, its value is saved as the newest smallest error, and the values of a₃, a₄, and t are saved.
4: At the end of a complete iteration of the triple-nested for loop, the smallest error is compared to a user-defined tolerance. If the recorded error is less than the tolerance threshold, the algorithm concludes having found the characteristic a₃, a₄, and t values. Otherwise, the ranges for a₃, a₄, and t are updated to be in a tighter neighborhood around the values associated with the smallest position error norm. The process persists until the iteration limit is reached or a satisfactory position error norm is found.

### 3 Alternatives

While the above example is described in the context of operation around Sun-Earth L2 in the Earth-Sun system, the formation flying techniques apply to any Lagrange point in any system. For example, the techniques described can be used in cislunar space.

In some examples, the orbit of the starshade during the imaging phase needs to be fine-tuned using thrusters to maintain a correct spatial relationship between the star, the starshade, and the telescope.

### 4 Implementations

The approaches described above can be implemented, for example, using a programmable computing system executing suitable software instructions or it can be implemented in suitable hardware such as a field-programmable gate array (FPGA) or in some hybrid form. For example, in a programmed approach the software may include procedures in one or more computer programs that execute on one or more programmed or programmable computing system (which may be of various architectures such as distributed, client/server, or grid) each including at least one processor, at least one data storage system (including volatile and/or non-volatile memory and/or storage elements), at least one user interface (for receiving input using at least one input device or port, and for providing output using at least one output device or port). The software may include one or more modules of a larger program, for example, that provides services related to the design, configuration, and execution of data processing graphs. The modules of the program (e.g., elements of a data processing graph) can be implemented as data structures or other organized data conforming to a data model stored in a data repository.

The software may be stored in non-transitory form, such as being embodied in a volatile or non-volatile storage medium, or any other non-transitory medium, using a physical property of the medium (e.g., surface pits and lands, magnetic domains, or electrical charge) for a period of time (e.g., the time between refresh periods of a dynamic memory device such as a dynamic RAM). In preparation for loading the instructions, the software may be provided on a tangible, non-transitory medium, such as a CD-ROM or other computer-readable medium (e.g., readable by a general or special purpose computing system or device), or may be delivered (e.g., encoded in a propagated signal) over a communication medium of a network to a tangible, non-transitory medium of a computing system where it is executed. Some or all of the processing may be performed on a special purpose computer, or using special-purpose hardware, such as coprocessors or field-programmable gate arrays (FPGAs), dedicated, application-specific integrated circuits (ASICs), or graphics processing units GPUs (e.g., for efficient execution of large language models or other machine learning/artificial intelligence models). The processing may be implemented in a distributed manner in which different parts of the computation specified by the software are performed by different computing elements. Each such computer program is preferably stored on or downloaded to a computer-readable storage medium (e.g., solid state memory or media, or magnetic or optical media) of a storage device accessible by a general or special purpose programmable computer, for configuring and operating the computer when the storage device medium is read by the computer to perform the processing described herein. The inventive system may also be considered to be implemented as a tangible, non-transitory medium, configured with a computer program, where the medium so configured causes a computer to operate in a specific and predefined manner to perform one or more of the processing steps described herein.

A number of embodiments of the invention have been described. Nevertheless, it is to be understood that the foregoing description is intended to illustrate and not to limit the scope of the invention, which is defined by the scope of the following claims. Accordingly, other embodiments are also within the scope of the following claims. For example, various modifications may be made without departing from the scope of the invention. Additionally, some of the steps described above may be order independent, and thus can be performed in an order different from that described.

What is claimed is:

1. A system for planning a mission for a plurality of spacecraft flying in formation, the system comprising:
an input for receiving data representing a sequence of spatial configurations of the plurality of spacecraft;
a retargeting module configured to generate instructions for causing the plurality of spacecraft to transition between spatial configurations of the sequence of spatial configurations, including determining a trajectory with periods of fuel-free motion and periods of actuated motion according to a fuel limitation constraint for at least one spacecraft of the plurality of spacecraft.

2. The system of claim 1 wherein a first spacecraft of the plurality of spacecraft is in a halo orbit around a Lagrange point.

3. The system of claim 2 wherein the Lagrange point is Sun-Earth L2.

4. The system of claim 2 wherein a second spacecraft is in an orbit substantially affected by two astronomical bodies.

5. The system of claim 4 wherein the second spacecraft's orbit is substantially affected by solar radiation pressure.

6. The system of claim 5 wherein the second spacecraft is under the fuel limitation constraint.

7. The system of claim 6 wherein the trajectory is determined using an approximate analytical solution to the circular restricted three-body problem with non-Hamiltonian solar radiation pressure.

8. The system of claim 7 wherein determining the trajectory includes predicting a location of the first spacecraft using an approximate analytical solution to the circular restricted three-body problem.

9. The system of claim 1 further comprising an output for providing a mission plan including the instructions to at least some spacecraft of the plurality of spacecraft.

10. The system of claim 1 wherein at least one spacecraft is a telescope and at least one spacecraft is a starshade.

11. The system of claim 10 wherein the mission includes observing a plurality of target stars to detect exoplanets.

12. The system of claim 11 further comprising an ordering module configured to determine the sequence of spatial configurations based at least in part on the locations of the plurality of target stars.

13. The system of claim 11 wherein the trajectory is further determined according to a time constraint.

14. The system of claim 13 wherein the time constraint is based in part on a predetermined integration time for observing the target stars.

15. The system of claim 11 wherein a first spatial configuration of the sequence of spatial configurations locates the starshade along a line-of-sight between the telescope and a first star of the plurality of target stars.

16. The system of claim 15 wherein the first spatial configuration locates the starshade at a predetermined distance from the telescope such that the starshade occludes light from the first target star from reaching the telescope while allowing light from exoplanets orbiting the first target star to reach the telescope.

17. The system of claim 1 wherein the trajectory is determined using naturally occurring dynamics.

18. A formation of a plurality spacecraft wherein one or more of the spacecraft is configured to:
receive instructions for causing the plurality of spacecraft to transition between spatial configurations of the sequence of spatial configurations, including determining periods of fuel-free motion and periods of actuated motion according to a fuel limitation constraint for at least one spacecraft of the plurality of spacecraft; and
execute the instructions to cause the plurality of spacecraft to transition between spatial configurations of the sequence of spatial configurations.

19. A method for operating a formation of a plurality of spacecraft, the method comprising:
receiving instructions for causing the plurality of spacecraft to transition between spatial configurations of the sequence of spatial configurations, including determining periods of fuel-free motion and periods of actuated motion according to a fuel limitation constraint for at least one spacecraft of the plurality of spacecraft; and
executing the instructions to cause the plurality of spacecraft to transition between spatial configurations of the sequence of spatial configurations.

20. Software embodied on a non-transitory, computer readable medium, the software comprising instructions for causing one or more spacecraft of a plurality of spacecraft to:
receive instructions for causing the plurality of spacecraft to transition between spatial configurations of the sequence of spatial configurations, including determining periods of fuel-free motion and periods of actuated motion according to a fuel limitation constraint for at least one spacecraft of the plurality of spacecraft; and
execute the instructions to cause the plurality of spacecraft to transition between spatial configurations of the sequence of spatial configurations.
